(19) United States
(12) Patent Application Publication
(10) Pub. No.: US 2014/0115239 A1
(43) Pub. Date: Apr. 24, 2014

(54) METHOD OF MANAGING DATA IN NONVOLATILE MEMORY DEVICE

(71) Applicant: Samsung Electronics Co., Ltd., Suwon-si (KR)

(72) Inventors: CHUN-UM KONG, Yongin-si (KR); Su-Ryun Lee, Suwon-si (KR); Youn-Won Park, Suwon-si (KR); Hong-Suk Choi, Suwon-si (KR)

(73) Assignee: Samsung Electronics Co., Ltd., Suwon-si (KR)

(21) Appl. No.: 14/056,476

(22) Filed: Oct. 17, 2013

(30) Foreign Application Priority Data
Oct. 22, 2012 (KR) 10-2012-0117373

(51) Int. Cl. G06F 12/02

(52) U.S. Cl. CPC G06F 12/0246
USPC 711/103

(57) ABSTRACT

A method of managing data in a nonvolatile memory device. The method includes providing a nonvolatile memory device having a hot region and a cold region. The hot region includes first through n-th blocks. Input pages having metadata are received from a host. The input pages are sequentially written to the first through n-th blocks. Valid pages are identified from the input pages written to the first block after the n-th block is written. The valid pages are written to the cold region.

This application claims priority to Korean Patent Application No. 10-2012-0117373 filed on Oct. 22, 2012 in the Korean Intellectual Property Office, the disclosure of which is herein incorporated by reference in its entirety.

### TECHNICAL FIELD

The present inventive concept relates to a memory device, and more particularly, to a method of managing data in a nonvolatile memory device.

### DISCUSSION OF THE RELATED ART

Nonvolatile memory devices are widely used in embedded systems such as home electronic appliances, communications devices and set-top boxes.

Nonvolatile memory devices can be used as both random access memory (RAM), which can be freely erased and written to, and read only memory (ROM), which can retain stored data even when a power supply is not present.

Flash memory is a common form of nonvolatile memory. A flash memory is a nonvolatile memory device in which memory cells may be electrically deleted and rewritten to. As compared to a storage medium based on a magnetic disk, flash memory tends to utilize less power and have an at least comparable access time. Further, since flash memory is compact in size, it is suitable for portable devices.

Data may only be rewritten to a flash memory in whole-page increments. When data recorded in a page of a nonvolatile memory is updated, the page becomes invalid. Thus, a new page is allocated, and the updated data is recorded in the new page along with all of the data of the old page that was not updated. Here, if there is not enough available space in the nonvolatile memory, garbage collection is performed to reclaim pages that were deemed to be invalid and to thereby increase the available space.

The time required to perform garbage collection acts as a load on the performance of the nonvolatile memory. Therefore, as the time required to perform garbage collection during the operation of the nonvolatile memory is reduced, the overall performance of the nonvolatile memory increases.

### SUMMARY

Aspects of the present inventive concept provide a method of managing data in a nonvolatile memory device, in which the time required to perform garbage collection is reduced, and wear leveling is unnecessary.

However, aspects of the present inventive concept are not restricted to the particular examples set forth herein. The above and other aspects of the present inventive concept will become more apparent to one of ordinary skill in the art to which the present inventive concept pertains by referencing the detailed description of the present inventive concept given below.

According to an aspect of the present inventive concept, there is provided a method of managing data in a nonvolatile memory device, the method includes providing a nonvolatile memory device. The nonvolatile memory device includes a hot region which has first through n-th blocks and a cold region. Input pages having metadata from a host are received. The input pages are sequentially written to the first through n-th blocks. Valid pages are identified from the input pages written to the first block after the n-th block is written. The valid pages are written to the cold region. Here n is a positive integer.

According to an aspect of the present inventive concept, there is provided a method of managing data in a nonvolatile memory device. The method includes providing a nonvolatile memory device including a hot region which has first through n-th blocks and a cold region. An input stream is received. The input stream includes a plurality of input pages from a host. The input stream is sequentially written to the first through n-th blocks. Moreover, p first threshold pages of the first block are sequentially written to the second through n-th blocks after the receiving of the input stream from the host is completed. Valid pages are identified from the input pages written to the first block after the n-th block is written. The valid pages are written to the cold region, wherein n is a positive integer, and p is a positive integer.

### BRIEF DESCRIPTION OF THE DRAWINGS

The above and other aspects and features of the present inventive concept will become more apparent by describing in detail exemplary embodiments thereof with reference to the attached drawings, in which:

FIG. 1 is a diagram illustrating types of blocks included in a nonvolatile memory device according to exemplary embodiments of the present inventive concept;

FIG. 2 is a flowchart illustrating a method of managing data in a nonvolatile memory device according to an exemplary embodiment of the present inventive concept;

FIGS. 3 through 6 are diagrams illustrating changes in blocks of a nonvolatile memory device according to an exemplary embodiment of the present inventive concept;

FIG. 7 is a flowchart illustrating a method of managing data in a nonvolatile memory device according to an exemplary embodiment of the present inventive concept;

FIGS. 8 and 9 are diagrams illustrating changes in blocks of a nonvolatile memory device according an exemplary embodiment of the present inventive concept;

FIGS. 10 through 13 are diagrams illustrating changes in blocks of a nonvolatile memory device according to an exemplary embodiment of the present inventive concept;

FIGS. 14 and 15 are diagrams illustrating a process of writing pages of a second block to other blocks according to an exemplary embodiment of the present inventive concept;

FIG. 16 is a flowchart illustrating a method of managing data in a nonvolatile memory device according to an exemplary embodiment of the present inventive concept;

FIGS. 17 and 18 are diagrams illustrating changes in blocks of a nonvolatile memory device according to an exemplary embodiment of the present inventive concept;

FIG. 19 is a block diagram of a memory system 1000 according to exemplary embodiments of the present inventive concept;

FIG. 20 is a block diagram of an applied example of the memory system 1000 shown in FIG. 19 according to an exemplary embodiment of the present inventive concept; and

FIG. 21 is a block diagram of a computing system 3000 including a memory system 2000 of FIG. 20 according to an exemplary embodiment of the present inventive concept.

### DETAILED DESCRIPTION OF EXEMPLARY EMBODIMENTS

The present inventive concept will now be described more fully hereinafter with reference to the accompanying drawings, in which preferred embodiments of the inventive concept are shown. This inventive concept may, however, be embodied in different forms and should not be construed as limited to the embodiments set forth herein. The same reference numbers may indicate the same components throughout the specification. In the attached figures, the thickness of layers and regions may be exaggerated for clarity.

It will also be understood that when a layer is referred to as being “on” another layer or substrate, it can be directly on the other layer or substrate, or intervening layers may also be present.

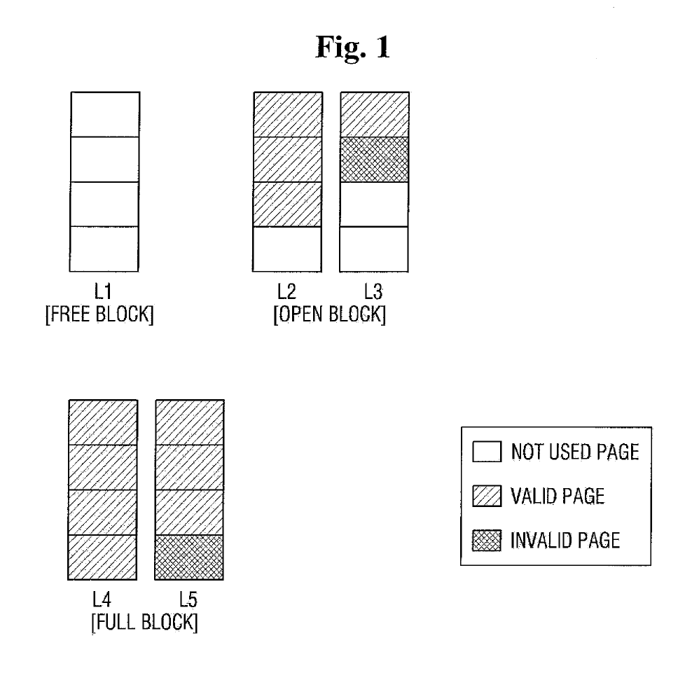

FIG. 1 is a diagram illustrating the types of blocks included in a nonvolatile memory device according to exemplary embodiments of the present inventive concept.

A hot region, a cold region, a block, and a page to be described below refer to logical spaces of a nonvolatile memory device, not particular physical regions of the nonvolatile memory device. Since the hot region, the cold region, the block, and the page refer to the logical spaces, corresponding physical spaces may vary whenever a write operation, an erase operation or the like is performed on them.

Referring to FIG. 1, the nonvolatile memory device according to exemplary embodiments of the present inventive concept may include various types of blocks. Examples of the blocks may include a free block, an open block, and a full block.

Hereinafter, a case where one block of the nonvolatile memory device includes four logical pages as shown in FIG. 1 will be described as an example. However, the present inventive concept is not limited to this example. However, one block may include more than four logical pages or less than four logical pages.

A free block (e.g., a first block L1) is a block that does not include a logical page. The number of such free blocks is largest when the nonvolatile memory device is first driven and is gradually reduced as the time in which the nonvolatile memory device is in use increases. When the number of free blocks is reduced to a predetermined number or less, as the time in which the nonvolatile memory device is in use increases further, the nonvolatile memory device generates a new free block through garbage collection.

An open block (e.g., a second or third block L2 or L3) is a block that stores a certain number of logical pages but does not yet store a maximum number of logical pages that it can store. For example, although each of the second block L2 and the third block L3 can store a maximum of four pages, three logical pages are stored in the second block L2, and two logical pages are stored in the third block L3.

When a logical page is input from a host to the nonvolatile memory device, it is generally stored in an open block (L2 or L3). When a logical page stored in a block is updated by the host, it is invalidated. For example, if a logical page identical to a logical page stored in a block (e.g., L3) is input from the host, the logical page stored in the block (e.g., L3) becomes an invalid page, and the input logical page is stored in a new block (e.g., a free block or another open block). For example, an invalid page in the third block L3 of FIG. 1 is a logical page stored in the third block L3 and subsequently updated by the host.

A full block (e.g., a fourth or fifth block L4 or L5) is a block that stores a maximum number of logical pages it can store. In FIG. 1, the full block may be a block that stores four logical pages. When a logical page stored in a full block is updated by the host, the logical page also becomes an invalid page. For example, after the fifth block L5 became a full block, one page in the fifth block L5 has been updated and thus become an invalid page.

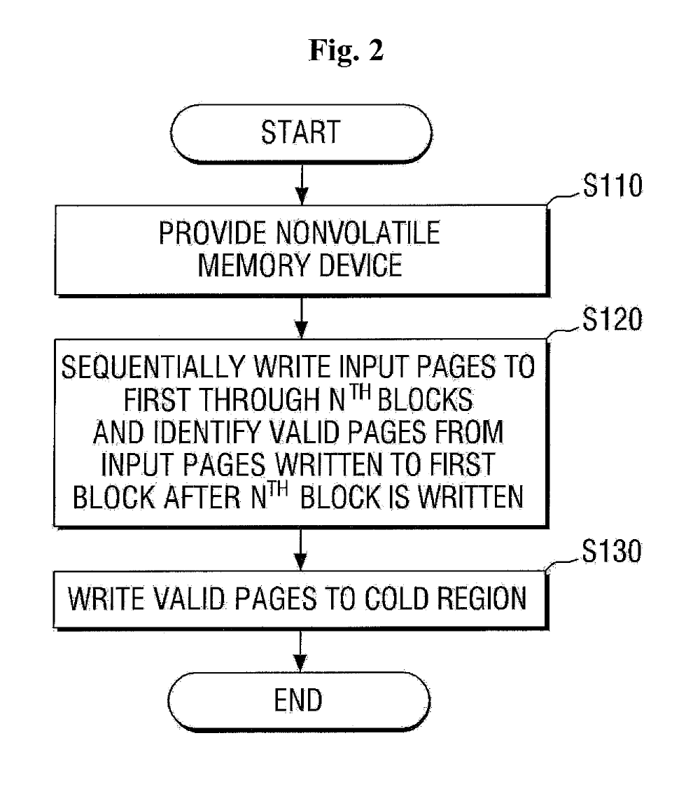

A method of managing data in a nonvolatile memory device according to an exemplary embodiment of the present inventive concept will now be described with reference to FIGS. 2 through 6.

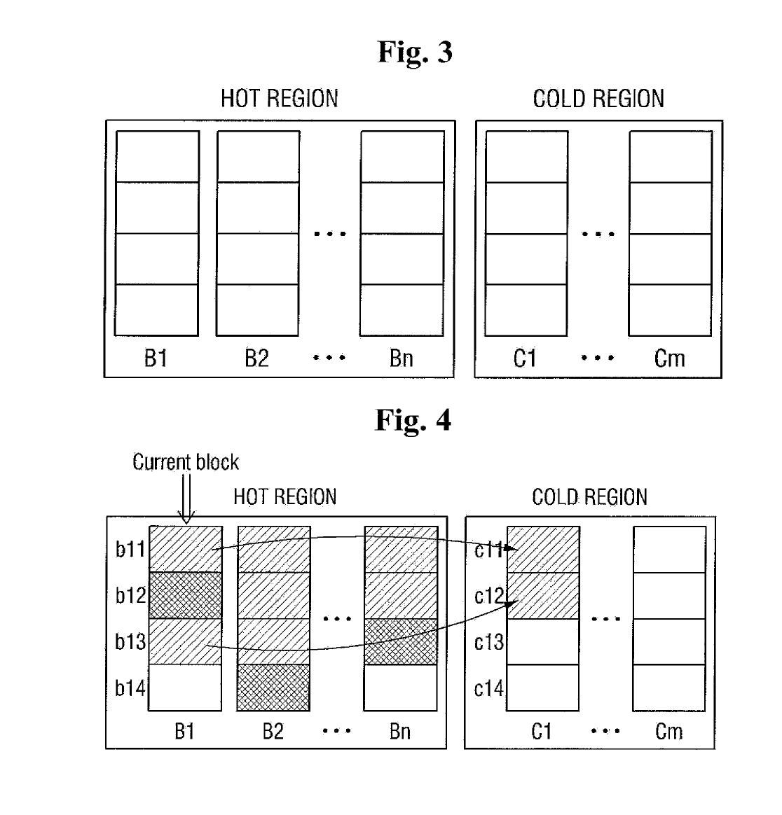

FIG. 2 is a flowchart illustrating a method of managing data in a nonvolatile memory device according to an exemplary embodiment of the present inventive concept. FIGS. 3 through 6 are diagrams illustrating changes in blocks of a nonvolatile memory device according to an exemplary embodiment of the present inventive concept.

Referring to FIG. 2, upon the start of the method (START), a nonvolatile memory device is provided (operation S110). Referring to FIG. 3, the nonvolatile memory device includes a hot region and a cold region. The hot region may include first through n^{th} blocks B1 through Bn (where n is a positive integer), and the cold region may include first through m^{th} blocks C1 through Cm (where m is a positive integer). Each of the first through n^{th} blocks B1 through Bn and each of the first through m^{th} blocks C1 through Cm may have a plurality of pages (e.g., four pages as shown in FIG. 3), and pages input from a host may be written to the above pages.

The hot region is a region that is frequently updated by the host. For example, the hot region is a region to which pages input from the host are written. Blocks included in the hot region undergo frequent page updates and garbage collection. The cold region is a region to which pages that are not updated frequently from among the pages input from the host are written. Pages written to the cold region are not updated frequently. Therefore, compared with the hot region, the cold region includes a relatively small number of invalid pages.

Where the nonvolatile memory device is divided into the hot region and the cold region, garbage collection can be performed only on pages that are updated frequently. Therefore, the time required to perform garbage collection and the number of blocks on which garbage collection is performed can be reduced. Accordingly, efficient data management may be achieved.

Pages input from the host may include metadata. The metadata is updated more frequently than the primary data that the metadata describes. Therefore, after the metadata is written to blocks of the nonvolatile memory device, it often becomes invalid data within a relatively short period of time. Thus, the metadata exists as valid data for only a limited time. For this reason, if the metadata and the primary data are managed separately within the hot region and the cold region, respectively, according to an exemplary embodiment of the present inventive concept, more efficient data management is possible compared with when the primary data and the metadata are not separately managed.

The number of blocks included in the hot region may be greater than or equal to the number of blocks included in the cold region. For example, n≧m. Pages in the hot region are updated frequently, and data input from the host is continuously written to the hot region. Therefore, the greater the number of blocks in the hot region, the more efficiently the data management may be performed. On the other hand, pages selected from input pages written to the hot region are written to the cold region. Therefore, the cold region may have a smaller number of blocks than the number of blocks included in the hot region. For example, the number of blocks included in the hot region may be three or four times the number of blocks included in the cold region.

Referring back to FIG. 2, valid pages are identified from input pages (operation S120). For example, pages having metadata are input from the host. The input pages are sequentially written to the first through n^{th} blocks B1 through Bn of the hot region. For example, the pages input from the host are written to the first through n^{th} blocks B1 through Bn in a round-robin fashion. Referring to FIG. 4, the pages input from the host are written to the hot region sequentially from the first block B1 to the n^{th} block Bn.

After the n^{th} block Bn is written, valid pages are identified from the input pages written to the first block B1. For example, after the input pages are written to the n^{th} block Bn, the hot region is written again, starting from the first block B1. Here, valid pages are identified from the input pages written to the first block B1. Referring to FIG. 4, pages b11 and b13 of the first block B1 are valid pages.

Referring back to FIG. 2, if at least one valid page is identified from the input pages written to the first block B1, it is written to the cold region (operation S130). Referring to FIG. 4, the page b11 identified as a valid page may be written to a page c11 of the first block C1, and the page b13 identified as a valid page may be written to a page c12 of the first block C1.

Like writing input pages to the hot region, writing valid pages to the cold region may be performed in a round-robin fashion. For example, since the cold region includes the first through m^{th} blocks C1 through Cm, valid pages may be written to the cold region sequentially from the first block C1 to the m^{th} block Cm. Then, valid pages may be written again to the cold region sequentially from the first block C1.

Since the hot region includes a sufficient number of blocks, if valid pages do not change to invalid pages while the first through n^{th} blocks B1 through Bn of the hot region are written sequentially, they can be determined to be pages that are not updated frequently. Therefore, valid pages included in the first block B1 of the hot region may be written to the cold region, such that the valid pages which are not updated frequently are collected in the cold region. Ultimately, garbage collection can be performed only on the hot region which includes a large number of invalid pages due to frequent updates. Thus, the frequency of garbage collection can be reduced.

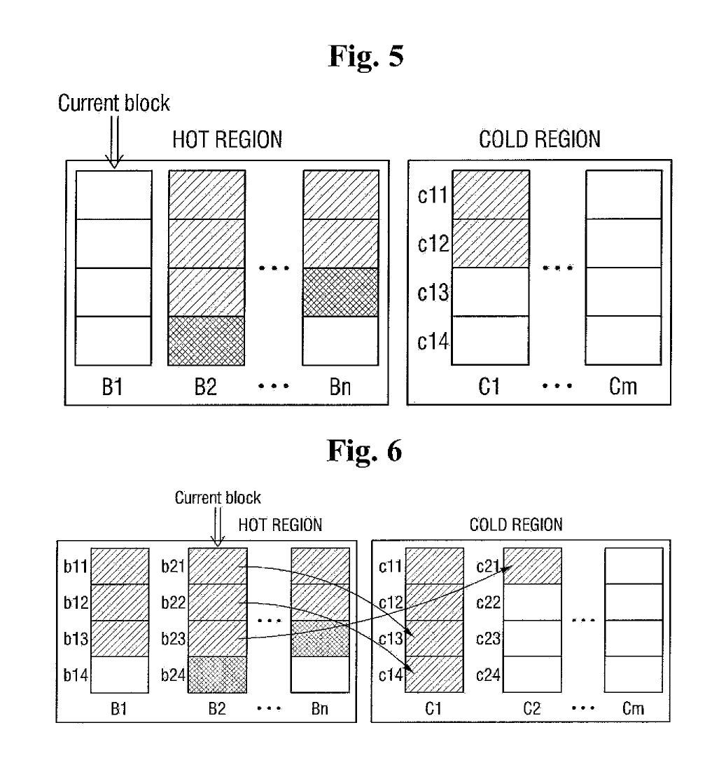

After the valid pages of the first block B1 are written to the cold region, no valid pages exist in the first block B1. Accordingly, referring to FIG. 5, the first block B1 may become a free block. After the first block B1 becomes a free block, pages input from the host are written again to the first block B1.

The second block B2 can also be changed to a free block in the way described above, and then input pages can be written to the second block B2. Referring to FIG. 6, after input pages are written to the second block B1, valid pages are identified from the input pages written to the second block B2. Since pages b21 through b23 are valid pages, the page b21 is written to a page c13, the page b22 is written to a page c14, and the page b23 is written to a page c21.

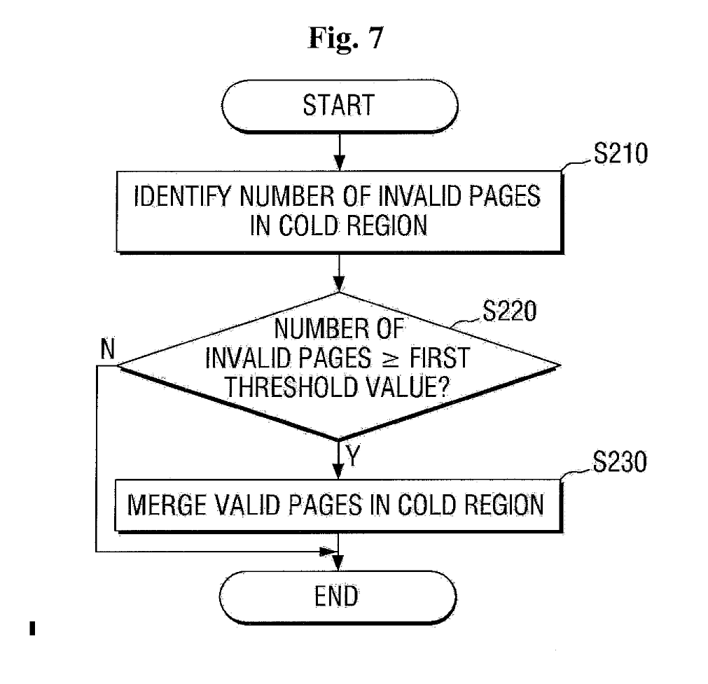

A method of managing data in a nonvolatile memory device according to an exemplary embodiment of the present inventive concept will now be described with reference to FIGS. 7 through 9.

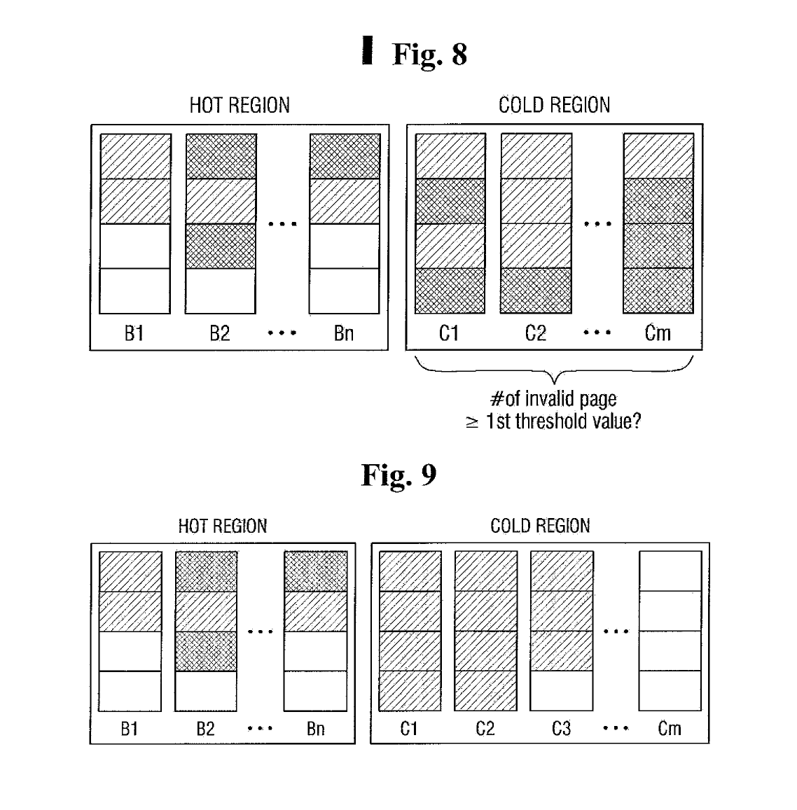

FIG. 7 is a flowchart illustrating a method of managing data in a nonvolatile memory device according to an exemplary embodiment of the present inventive concept. FIGS. 8 and 9 are diagrams illustrating changes in blocks of a nonvolatile memory device according to an exemplary embodiment of the present inventive concept.

Pages of a cold region may be updated, albeit not as frequently as those of a hot region. Therefore, not only are valid pages of the hot region written to the cold region, but also garbage collection is performed on the cold region. The garbage collection may be performed as follows.

Referring to FIG. 7, upon the start of the method (START), the number of invalid pages in the cold region is identified (operation S210). Since the cold region can be updated, albeit not frequently, valid pages may change to invalid pages. Referring to FIG. 8, as time passes, invalid pages may be created in the cold region.

Referring to FIG. 7, it is determined whether the number of the invalid pages is greater than or equal to a first threshold value (operation S220). When the number of the invalid pages in the cold region is greater than or equal to the first threshold value, valid pages remaining in the cold region are merged (operation S230), so that only valid data exists in the cold region. Referring to FIG. 9, when the number of the invalid pages of the cold region is equal to or greater than the first threshold value, valid pages remaining in the cold region are merged.

The first threshold value is not limited to a particular value and may be determined by a user according to the use and characteristics of the nonvolatile memory device.

The identifying of the number of the invalid pages in the cold region may be performed when a valid page of the hot region is written to the cold region. However, the present inventive concept is not limited thereto. For example, the identifying of the number of the invalid pages in the cold region can also be performed whenever an input page is written to the hot region.

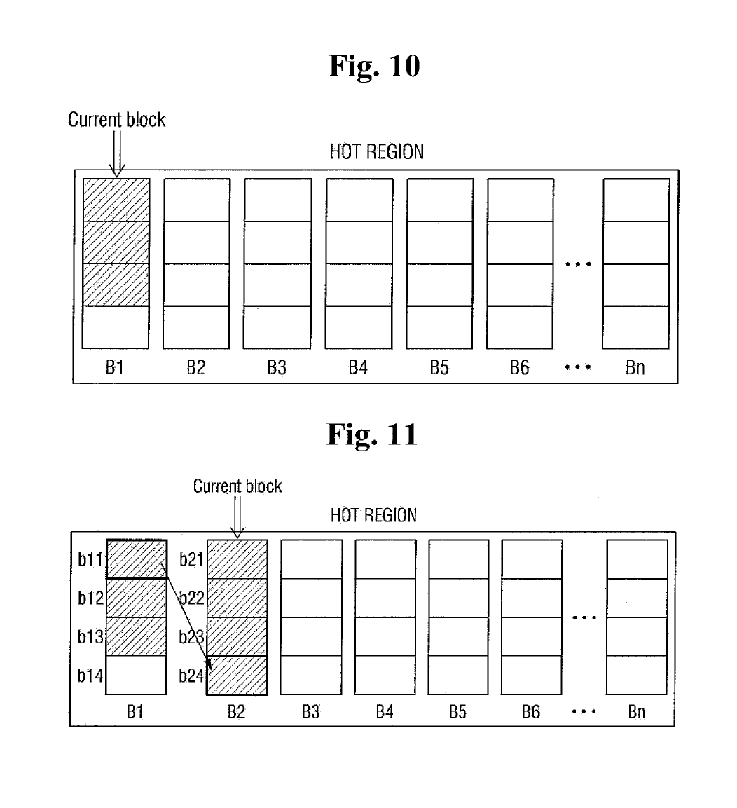

A method of managing data in a nonvolatile memory device according to an exemplary embodiment of the present inventive concept will now be described with reference to FIGS. 10 through 13.

FIGS. 10 through 13 are diagrams illustrating changes in blocks of a nonvolatile memory device according to an exemplary embodiment of the present inventive concept. The method of managing data in a nonvolatile memory device according to an exemplary embodiment of the present inventive concept is implemented in a hot region. Therefore, a cold region is omitted from FIGS. 10 through 13 for the sake of providing a clear and simple description.

The data management method described above with respect to FIGS. 2-6 is a method of writing pages input from a host to each of a hot region and a cold region. Here, the data management method described with respect to FIGS. 10-13 writes input pages to the hot region.

Referring to FIG. 10, an input stream received from a host is written to a first block B1 of the hot region. One page or a plurality of pages to be written to blocks of the hot region may be input from the host. Therefore, one or more input pages provided to the hot region at a time will be referred to as an input stream.

In FIG. 10, the first block B1 includes p first threshold pages. Here, a first threshold page refers to the number of pages that are moved at a time to other block when pages included in the first block B1 are written to the other blocks. For example, the first threshold page may be a unit of pages that are written at a time to other block. For example, referring to FIG. 10, an input stream is written to the first block B1. Since the input stream includes three input pages, it is written to pages b11 through b13 of the first block B1. Here, if the pages b11 through b13 are to be written one by one to other blocks, one page is the first threshold page. Ultimately, the first block B includes three first threshold pages.

Referring to FIG. 11, after the first block B1 is written, an input stream received from the host is written to a second block B2. In FIG. 11, the input stream includes three input pages and is written to pages b21 through b23 of the second block B2. After the input stream is written to the second block B2, a first threshold page of the first block B1 is additionally written to the second block B2. Specifically, the pages b1 through b13 of the first block B1 are written to other blocks on a first threshold page-by-first threshold page basis. Since the first threshold page was determined to be one page as described above, the page b11 of the first block B1 is written to a page b24 of the second block B2.

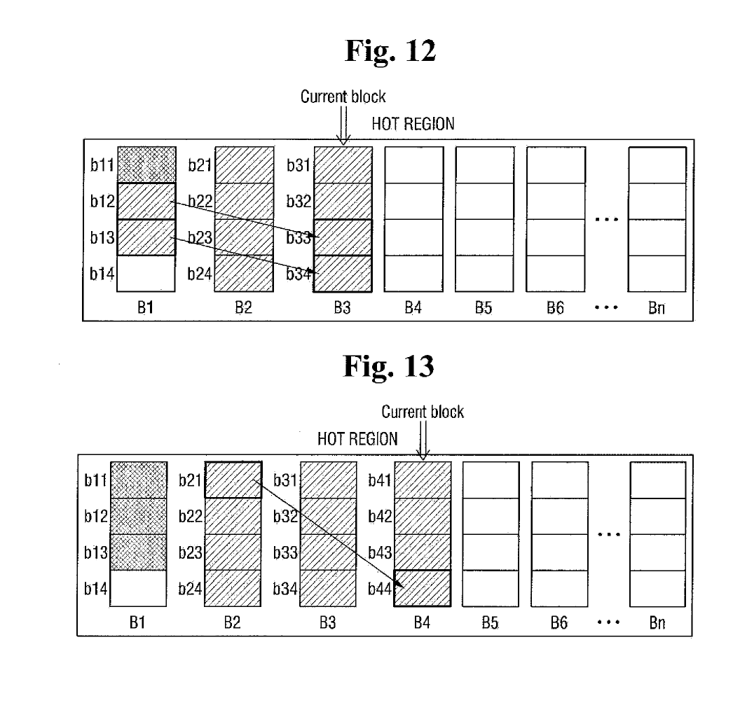

Referring to FIG. 12, after the second block B2 is written, a third block B3 begins to be written. Here, since the page b11 of the first block B1 was written to the page b24 of the second block B2, page b24 becomes invalid.

An input stream is written to pages b31 and b32 of the third block B3, the page b12 of the first block B1 is written to a page b33 of the third block B3, and the page b13 of the first block B1 is written to a page b34 of the third block B3. For example, the remaining pages b12 and b13 of the first block B1 are written to the third block B3 on a first threshold page-by-first threshold page basis until the third block B3 is filled.

Referring to FIG. 13, after the third block B3 is written, a fourth block B4 begins to be written. Since the pages b12 and b13 of the first block B1 were written to the pages b33 and b34 of the third block B3, pages b33 and b34 become invalid. In addition, since no valid pages are remaining in the first block B1, valid pages of the second block B2 are written to other blocks on a first threshold page-by-first threshold page basis. For example, an input stream is written to pages b41 through b43 of the fourth block B4, and the page b21 (i.e., a first threshold page) of the second block B2 is written to a page b44 of the fourth block B4.

Thus, the first block B1 includes the p first threshold pages (where p is shown as being equal to three in FIGS. 10 through 13), and the p first threshold pages b11 through b13 of the first block B1 are sequentially written to at least one of the second through n^{th} blocks (where n is shown as being equal to three in FIGS. 10 through 13). Here, writing the first threshold page can be performed alternately with sequentially writing input streams to the second through n^{th} blocks B2 through Bn.

If the first threshold page refers to the number of valid pages, only the valid pages, not invalid pages, are written to other blocks, thus contributing to an increase in efficiency.

In FIGS. 10 through 13, the first through fourth blocks B1 through B4 are illustrated as free blocks before input streams are written to the first through fourth blocks B1 through B4. However, the present inventive concept is not limited thereto. For example, the first through fourth blocks B1 through B4 may also be open blocks or full blocks. In this case, input streams may be written to the first through fourth blocks B1 through B4 after garbage collection is performed.

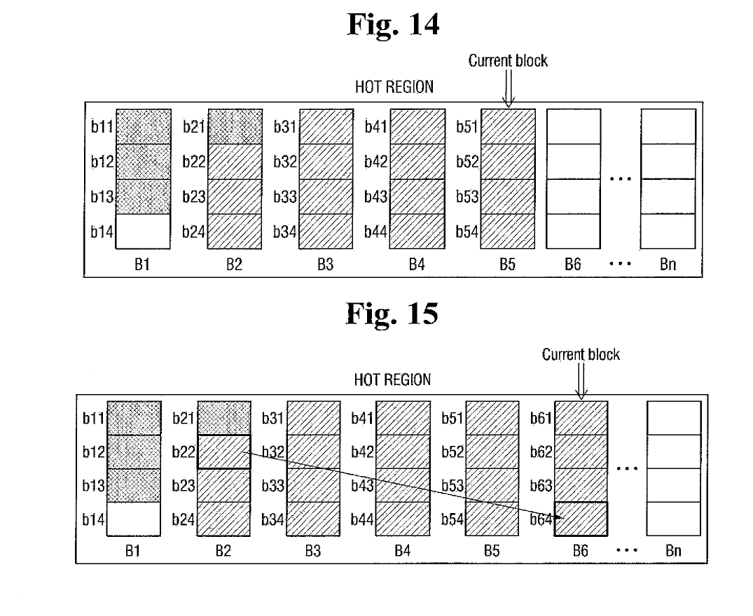

Writing a second block of a hot region to other blocks will now be described with reference to FIGS. 14 through 15.

FIGS. 14 and 15 are diagrams illustrating a process of writing pages of a second block to other blocks. For the purposes of providing a clear and simple description, a cold region is omitted.

After p first threshold pages of a first block B1 are all written to other blocks, first threshold page of a second block B2 is written to other blocks. For example, q (where q is a positive integer) first threshold pages of the second block B2 are written to at least one of the blocks to which the p first threshold pages are not written from among first through n^{th} blocks B1 through Bn. For example, referring to FIG. 14, the second block B2 includes four first threshold pages (three valid pages and one invalid page), and an input stream received from a host includes four input pages. In FIG. 14, the number of pages included in the input stream is equal to the number of pages included in the fifth block B5. For example, since the input stream is written to all of pages b51 through b54 of the fifth block B5, an unused page does not exist in the fifth block B5. Therefore, the first threshold page of the second block B2 cannot be written to the fifth block B5. Referring to FIG. 15, the sixth block B6 receives an input stream and writes input pages included in the input stream to pages b61 through b63 thereof. Since an unused page exists in the sixth block B6, a first threshold page of the second block B2 can be written to the sixth block B6. Therefore, the page b22 is written to a page b64 of the sixth block B6.

As described above, if pages included in one block of the hot region are distributed (written) to other blocks on a first threshold page-by-first threshold page basis, the time required to change the block of the hot region to a free block can be reduced. For example, as exemplified in FIGS. 10 through 13, if input pages and a first threshold page of another block are written to a block of the hot region, a block including invalid data only is generated naturally (see the first block B1 of FIG. 14). Therefore, to change a block of the hot region to a free block, garbage collection can be performed immediately without the need to move valid pages of the block to other blocks. However, if the data management method as described herein with respect to FIGS. 10-13 is not used, valid pages included in a block should be written to other blocks in order to write input pages to the block. For example, if the block consists of valid pages only, all of the valid pages should be moved in order to change the block to a free block. This may require a relatively long period of time and may cause a timeout.

In addition, to write input pages received from the host, the blocks of the hot region are sequentially changed to free blocks in a round-robin fashion. Accordingly, the time required to scan appropriate blocks to be changed to free blocks may be saved.

Furthermore, the first threshold page of the first block B1 is not written to a particular free block. Instead, the first threshold page is written to unused pages of a block to which input pages are written. Therefore, the number of write and erase operations performed on blocks can be reduced.

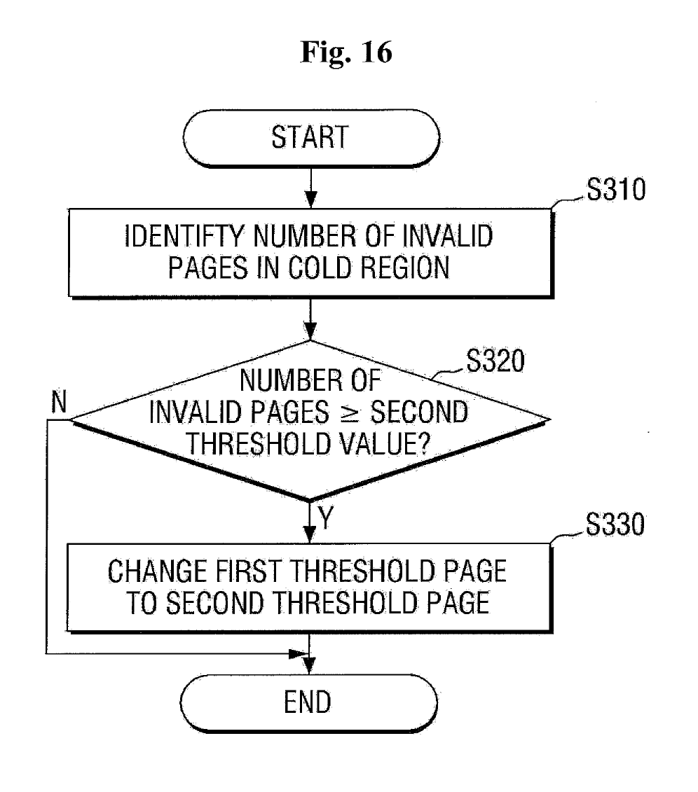

A method of managing data in a nonvolatile memory device according to an exemplary embodiment of the present inventive concept will now be described with reference to FIGS. 16 through 18.

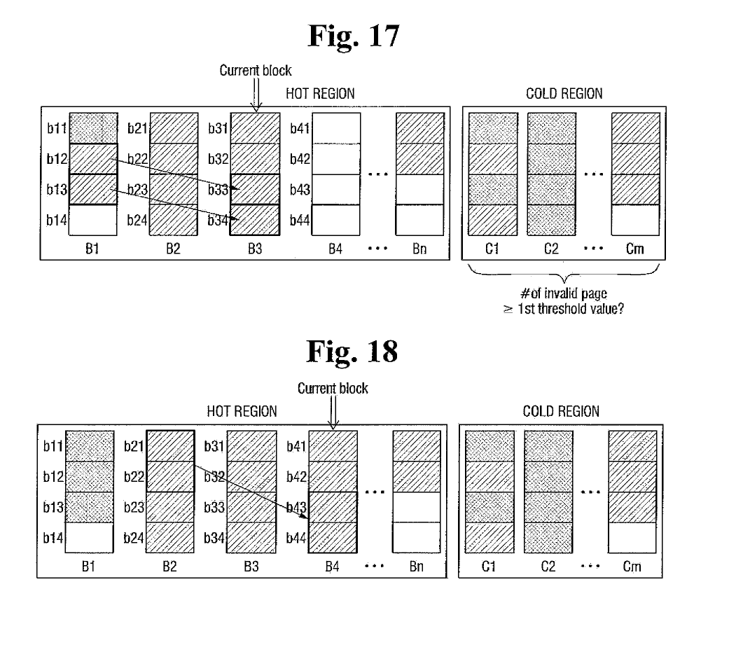

FIG. 16 is a flowchart illustrating a method of managing data in a nonvolatile memory device according to an exemplary embodiment of the present inventive concept. FIGS. 17 and 18 are diagrams illustrating changes in blocks of a nonvolatile memory device according to an exemplary embodiment of the present inventive concept.

Referring to FIG. 16, upon the start of the method (START), looking at the valid pages written to a cold region, the number of pages which have become invalid pages is identified (operation 5310). Then, it is determined whether the number of the invalid pages is equal to or greater than a second threshold value (operation S320). As described above, valid pages written to the cold region can also be changed to invalid pages. The second threshold value can be set according to the use and characteristics of the nonvolatile memory device. When the number of the invalid pages is equal to or greater than the second threshold value, first threshold page is changed to a second threshold page (operation S330).

For example, referring to FIG. 17, first threshold page of a first block B1 in a hot region is written to a third block B3 (b12 to b33 and b13 to b34).

However, if the number of invalid data of the cold region is equal to or greater than the second threshold value, the first threshold page is changed to a second threshold page. In FIG. 18, a case where first threshold page is changed to a second threshold page is illustrated. Referring to FIG. 18, a second threshold page of a second block B2 is written to a fourth block B4. For example, pages b21 and b22 of the second block B2 are written to pages b43 and b44 of the fourth block B4. A second threshold page has a different number of pages from a first threshold page and is larger than the first threshold page. As illustrated in FIGS. 17 and 18, a first threshold page includes one page, and a second threshold page includes two pages. However, the present inventive concept is not limited thereto. For example, the first threshold page may include one page, and the second threshold page may include three pages. Whether the number of the invalid pages is equal to or greater than the second threshold value may be determined whenever a valid page is written to the cold region. Like the first threshold page, the second threshold page may include valid pages.

The second threshold value may be equal to the first threshold value. When the first threshold value and the second threshold value are equal, merging valid pages of the cold region may be performed at the same time as changing first threshold page to a second threshold page. Alternatively, the first threshold page may be changed to the second threshold page when the number of the invalid pages is greater than or equal to the second threshold value, and the second threshold page may be changed to the first threshold page when the number of the invalid pages is greater than or equal to the first threshold value.

When valid pages written to the cold region are provided to the hot region as input pages, they may become invalid pages. Therefore, an increase in the number of the invalid pages in the cold region indicates an increase in the number of the input pages provided to the hot region. When the number of the input pages provided to the hot region increases, if the first threshold page is maintained, time might be taken to distribute the first threshold page of the first block B1 to other blocks. This is because the first threshold page is not written to a target block if the number of pages input from the host is equal to or greater than the number of pages in the target block (see FIG. 14). Therefore, to reduce the time required to distribute the first threshold page, the first threshold page may be changed to a second threshold page. Accordingly, the number of times that threshold pages are written to other blocks can be reduced.

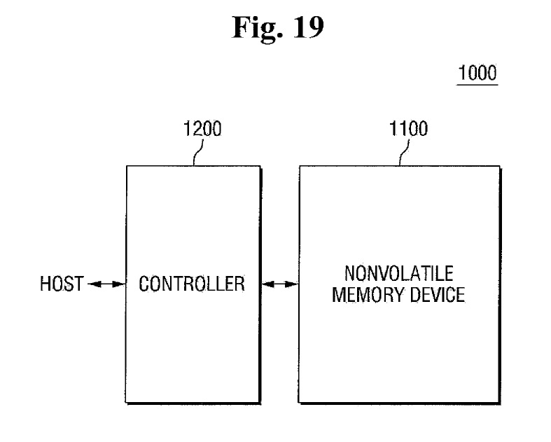

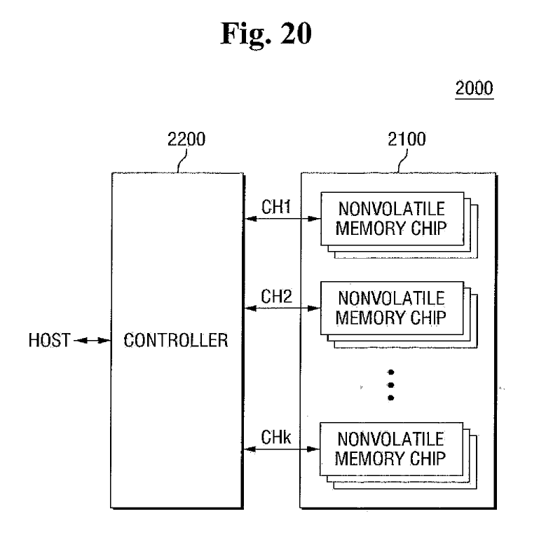

A memory system according to exemplary embodiments of the present inventive concept will now be described with reference to FIGS. 19 through 21.

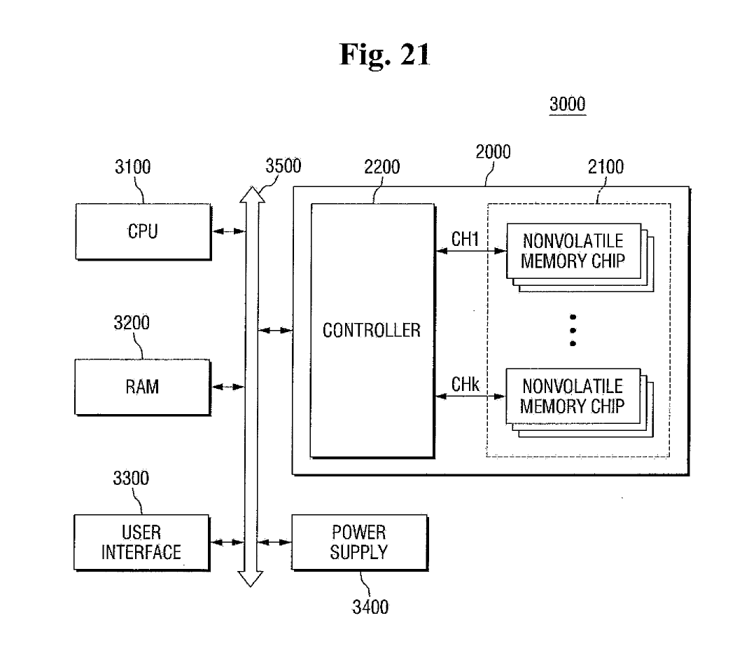

FIG. 19 is a block diagram of a memory system 1000 according to exemplary embodiments of the present inventive concept. FIG. 20 is a block diagram of an applied example of the memory system 1000 shown in FIG. 19. FIG. 21 is a block diagram of a computing system 3000 including a memory system 2000 of FIG. 20.

Referring to FIG. 19, the memory system 1000 includes a nonvolatile memory device 1100 and a controller 1200.

The nonvolatile memory device 1100 may implement one or more of the data management methods described above.

The controller 1200 is connected to a host and the nonvolatile memory device 1100. The controller 1200 is configured to access the nonvolatile memory device 1100 in response to a request from the host. For example, the controller 1200 may be configured to control read, write, erase and background operations of the nonvolatile memory device 1100. The controller 1200 may be configured to provide an interface between the nonvolatile memory device 1100 and the host. The controller 1200 may be configured to drive firmware for controlling the nonvolatile memory device 1100.

The controller 1200 further includes well-known components such as a random access memory (RAM), a processing unit, a host interface, and a memory interface. The RAM is used as at least one of an operation memory of the processing unit, a cache memory between the nonvolatile memory device 1100 and the host, and a buffer memory between the nonvolatile memory device 1100 and the host. The processing unit controls the overall operation of the controller 1200.

The host interface includes a protocol for data exchange between the host and the controller 1200. For example, the controller 1200 may be configured to communicate with an external device (e.g., the host) using at least one of various interface protocols such as a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, and an integrated drive electronics (IDE) protocol. The memory interface may interface with the nonvolatile memory device 1100. For example, the memory interface includes a NAND interface or a NOR interface.

The memory system 1000 may further include an error correction block. The error correction block may be configured to detect errors of data read from the nonvolatile memory device 1100 and correct the detected errors using error correcting codes (ECC). For example, the error correction block may be provided as an element of the controller 1200. The error correction block can also be provided as an element of the nonvolatile memory device 1100.

The controller 1200 and the nonvolatile memory device 1100 may be integrated into one semiconductor device. For example, the controller 1200 and the nonvolatile memory device 1100 may be integrated into one semiconductor device to form a memory card. For example, the controller 1200 and the nonvolatile memory device 1100 may be integrated into one semiconductor device to form a personal computer (PC) card (e.g., Personal Computer Memory Card International Association (PCMCIA)), a compact flash card (CF), a smart media card (SM, SMC), a memory stick, a multimedia card (e.g., MMC, RS-MMC, MMCmicro), a SD card (e.g., SD, miniSD, microSD, SDHC), or a universal flash storage (UFS).

Alternatively, the controller 1200 and the nonvolatile memory device 1100 may be integrated into one semiconductor device to form a solid state drive (SSD). The SSD includes a storage device which stores data in a semiconductor memory. When the memory system 1000 is used as an SSD, the operation speed of the host connected to the memory system 1000 may increase significantly.

The memory system 1000 may be implemented in a computer, an ultra-mobile PC (UMPC), a workstation, a net-book, a personal digital assistant (PDA), a portable computer, a web tablet, a wireless phone, a mobile phone, a smart phone, a dedicated e-book reading device, a portable multimedia player (PMP), a portable game device, a navigation device, a black box, a digital camera, a three-dimensional television, a digital audio recorder, a digital audio player, a digital picture recorder, a digital picture player, a digital video recorder, a digital video player, a device capable of transmitting/receiving information in wireless environments, one of various electronic devices constituting a home network, one of various electronic devices constituting a computer network, one of various electronic devices constituting a telematics network, a radio frequency identification (RFID) device, or one of various components constituting a computing system.

The nonvolatile memory device 1100 or the memory system 1000 may be mounted using various forms of packages. The nonvolatile memory device or the memory system 1000 may be mounted using packages such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline integrated circuit (SOIC), shrink small outline package (SSOP), thin small outline package (TSOP), thin quad flat pack (TQFP), system in package (SIP), multi chip package (MCP), wafer-level fabricated package (WFP), and wafer-level processed stack package (WSP).

Referring to FIG. 20, the memory system 2000 includes a nonvolatile memory device 2100 and a controller 2200. The nonvolatile memory device 2100 includes a plurality of nonvolatile memory chips. The nonvolatile memory chips form multiple memory chip groups. Each of the memory chip groups has one common channel for communication with the controller 2200. For example, the nonvolatile memory chips may communicate with the controller 2200 through first through k^{th} channels CH1 through CHk.

In FIG. 20, a plurality of nonvolatile memory chips are connected to one channel. However, the memory system 2000 can be modified such that one nonvolatile memory chip is connected to one channel.

Referring to FIG. 21, the computing system 3000 includes a central processing unit (CPU) 3100, a RAM 3200, a user interface 3300, a power supply 3400, and a memory system 2000.

The memory system 2000 is electrically connected to the CPU 3100, the RAM 3200, the user interface 3300, and the power supply 3400 through a system bus 3500. Data provided through the user interface 3300 or processed by the CPU 3100 is stored in the memory system 2000.

In FIG. 21, the nonvolatile memory device 2100 is connected to the system bus 3500 through the controller 2200. However, the nonvolatile memory device 2100 can also be connected directly to the system bus 3500.

In FIG. 21, the memory system 2000 described above with reference to FIG. 20 is provided. However, the memory system 2000 can be replaced by the memory system 1000 described above with reference to FIG. 19.

Alternatively, the computing system 3000 may include all of the memory systems 1000 and 2000 described above with reference to FIGS. 10 and 20.

Those skilled in the art will appreciate that many variations and modifications can be made to the described exemplary embodiments without substantially departing from the principles of the present invention.

What is claimed is:

1. A method of storing data in a nonvolatile memory device, the method comprising:
providing a nonvolatile memory device comprising a cold region and a hot region comprising first through n-th blocks;
receiving one or more input pages having metadata from a host, sequentially writing the one or more input pages to the first through n-th blocks, and identifying one or more valid pages written to the first block after the n-th block is written from among the one or more input pages; and
writing the identified one or more valid pages to the cold region,
wherein n is a positive integer.

2. The method of claim 1, wherein the metadata is data pertaining to a description of primary data stored in the nonvolatile memory device.

3. The method of claim 1, wherein the cold region comprises first through m-th blocks, wherein in is a positive integer, and n≧m.

4. The method of claim 3, wherein the one or more valid pages are written to the cold region in a round-robin fashion.

5. The method of claim 1, further comprising changing the first block to a free block after the writing of the one or more valid pages to the cold region.

6. The method of claim 1, further comprising identifying a number of valid pages which have become invalid pages from among the one or more valid pages written to the cold region and merging valid pages remaining in the cold region when the number of the invalid pages is greater than or equal to a first threshold value.

7. The method of claim 1, wherein the first block comprises p first threshold pages and the method further comprises sequentially writing the p first threshold pages to at least one of a second through n-th blocks, wherein p is a positive integer.

8. The method of claim 7, wherein the first threshold page comprises valid pages.

8. The method of claim 7, wherein sequentially writing the p first threshold pages included in the first block to the at least one of the second through n-th blocks is performed alternately with the sequentially writing of the input pages to the second through n-th blocks.

10. The method of claim 7, further comprising writing each of q first threshold pages of the second block to at least one of blocks to which the p first threshold pages are not written from among the first through n-th blocks after writing all of the p first threshold pages to the at least one of the second through n-th blocks.

11. The method of claim 7, further comprising identifying the number of valid pages which have become invalid pages from among the valid pages written to the cold region and changing the first threshold page to a second threshold page when the number of the invalid pages is greater than or equal to a second threshold value.

12. A method of storing data in a nonvolatile memory device, the method comprising:
providing a nonvolatile memory device comprising a cold region and a hot region which comprises first through n-th blocks;
receiving an input stream which comprises a plurality of input pages from a host and sequentially writing the input stream to the first through n-th blocks;
sequentially writing p first threshold pages of the first block to a second through n-th blocks after the receiving of the input stream from the host is completed;
identifying one or more valid pages from the plurality of input pages written to the first block after the n-th block is written; and
writing the one or more valid pages to the cold region,
wherein n and p are positive integers.

13. The method of claim 12, wherein the plurality of input pages comprise metadata pertaining to a description of primary data stored in the nonvolatile memory device.

14. The method of claim 12, wherein the cold region comprises first through m-th blocks, wherein m is a positive integer, and n≧m.

15. The method of claim 14, further comprising:
identifying a number of valid pages which have become invalid pages from among the one or more valid pages written to the cold region;
merging valid pages remaining in the cold region when the number of the invalid pages is greater or equal to a first threshold value; and
changing the first threshold page to a second threshold page when the number of the invalid pages is greater than equal to a second threshold value.

16. The method of claim 15, wherein the first and second threshold page comprise valid pages.

17. A method for storing data in a nonvolatile memory device, the method comprising:
receiving data;
dividing the received data into a first and second portion, the first portion data being more likely to be updated than the second portion of the data;
storing the first portion of the data into a hot region of the nonvolatile memory device;
storing the second portion of the data into a cold region of the nonvolatile memory; and
performing garbage collection on the hot region of the nonvolatile memory more frequently than garbage collection is performed on the cold region of the nonvolatile memory.

18. The method of claim 17, wherein dividing the received data into a first and second portion includes identifying primary data from among the received data and categorizing the primary data for being stored in the second portion and identifying metadata pertaining to a description of the primary data and categorizing the metadata for being stored in the first portion.

19. The method of claim 1, wherein receiving the data comprises receiving one or more input pages having the metadata from a host, and
the steps of dividing and storing comprise:
sequentially writing the one or more input pages to a first through n-th blocks of the hot region, and identifying one or more valid pages written to the first block after the n-th block is written from among the one or more input pages; and
writing the identified one or more valid pages to the cold region,
wherein n is a positive integer.

20. The method of claim 19, wherein the cold region comprises first through m-th blocks, wherein m is a positive integer, and n≧m.
